(19) United States
(12) Patent Application Publication
(10) Pub. No.: US 2022/0371731 A1
(43) Pub. Date: Nov. 24, 2022

(54) CONTROL APPARATUS, FIRST MOBILE TERMINAL, METHOD, PROGRAM, AND RECORDING MEDIUM

(71) Applicant: NEC Corporation, Minato-ku, Tokyo (JP)

(72) Inventors: Toshiyuki TAMURA, Tokyo (JP); Hisashi FUTAKI, Tokyo (JP)

(73) Assignee: NEC Corporation, Minato-ku, Tokyo (JP)

(21) Appl. No.: 17/637,142

(22) PCT Filed: Sep. 1, 2020
(86) PCT No.: PCT/JP2020/033140

§ 371 Date: Aug. 4, 2022

(30) Foreign Application Priority Data
Sep. 4, 2019 (JP) 2019-161401

(51) Int. Cl. B64C 39/02; G08G 5/02; H04B 7/185; G05D 1/10; G05D 1/00

(52) U.S. Cl. CPC B64C 39/024; G08G 5/02; H04B 7/18502; G05D 1/101; G05D 1/0022; B64C 2201/146

(57) ABSTRACT

In order for a mobile terminal to land at an appropriate landing point in reaction to a change of an incident that may occur while the mobile terminal flies along a flight path, a control apparatus 100 includes: an information acquisition section 131 configured to acquire, according to a flight of a first mobile terminal (mobile terminal 200a) performed based on a flight path to a first landing point, information on one or more second landing points associated with the flight path to the first landing point; and a first communication processing section 133 configured to transmit the information on the one or more second landing points to the first mobile terminal (mobile terminal 200a) via a mobile communication network 300.

### TECHNICAL FIELD

The present invention relates to a control apparatus, a first mobile terminal, a method, a program, and a recording medium.

### BACKGROUND ART

Mobile terminals (drone or the like) that perform flight according to information on a flight path received from a server or the like via a communication network have been widely known.

For example, PTL 1 discloses configuring of a flight route of a flight apparatus based on a radio resource that can be allocated to a flight apparatus (mobile terminal) by a base station.

Further, PTL 2 discloses the following: when an operation administrator determines that a flight of a drone according to a flight plan is impossible, instructing a business terminal that manages the drone to carry out emergency landing (landing at an unscheduled landing point; the landing point is, for example, a riverbed, a branch office of the business operator, or the like).

Further, PTL 3 discloses the following: when it is determined that a drone is in a state capable of flying for approximately at least several minutes, transmitting, to the drone, countermeasure instruction information for guiding the drone to a landing point to allow its landing.

### CITATION LIST

### Patent Literature

[PTL 1] JP 2019-059258 A

[PTL 2] WO 2019/098017

[PTL 3] JP 2018-165115 A

### SUMMARY

### Technical Problem

However, for example, in the technique disclosed in PTL 2, for example, when a mobile terminal such as a drone cannot perform flight, for example, landing instruction at a landing point such as a riverbed, a branch office of a business operator, or the like is only performed for the mobile terminal. In other words, the techniques disclosed in the above-described patent literatures and the like including PTL 2 do not enable landing at an appropriate landing point in reaction to a change of an incident that may occur while the mobile terminal flies along a flight path.

An example object of the present invention is to provide a control apparatus, a first mobile terminal, a method, a program, and a recording medium that enable the mobile terminal to land at an appropriate landing point in reaction to a change of an incident that may occur while the mobile terminal flies along a flight path.

### Solution to Problem

A control apparatus according to the present invention includes: an information acquisition section configured to acquire, according to a flight of a first mobile terminal performed based on a flight path to a first landing point, information on one or more second landing points associated with the flight path to the first landing point; and a communication processing section configured to transmit the information on the one or more second landing points to the first mobile terminal via a communication network.

A first mobile terminal according to the present invention includes: a first communication processing section configured to receive, according to a flight of a first mobile terminal performed based on a flight path to a first landing point, information on one or more second landing points associated with the flight path to the first landing point via a communication network; and a control section configured to perform landing operation at a landing scheduled point different from the first landing point according to the information on the one or more second landing points.

A first method according to the present invention includes: acquiring, according to a flight of a first mobile terminal performed based on a flight path to a first landing point, information on one or more second landing points associated with the flight path to the first landing point; and transmitting the information on the one or more second landing points to the first mobile terminal via a communication network.

A second method according to the present invention includes: receiving, according to a flight of a first mobile terminal performed based on a flight path to a first landing point, information on one or more second landing points associated with the flight path to the first landing point via a communication network; and performing landing operation at a landing scheduled point different from the first landing point according to the information on the one or more second landing points.

A first program according to the present invention causes a processor to execute: acquiring, according to a flight of a first mobile terminal performed based on a flight path to a first landing point, information on one or more second landing points associated with the flight path to the first landing point; and transmitting the information on the one or more second landing points to the first mobile terminal via a communication network.

A second program according to the present invention causes a processor to execute: receiving, according to a flight of a first mobile terminal performed based on a flight path to a first landing point, information on one or more second landing points associated with the flight path to the first landing point via a communication network; and performing landing operation at a landing scheduled point different from the first landing point according to the information on the one or more second landing points.

A first non-transitory computer readable recording medium according to the present invention stores a program that causes a processor to execute: acquiring, according to a flight of a first mobile terminal performed based on a flight path to a first landing point, information on one or more second landing points associated with the flight path to the first landing point; and transmitting the information on the one or more second landing points to the first mobile terminal via a communication network.

A second non-transitory computer readable recording medium according to the present invention stores a program that causes a processor to execute: receiving, according to a flight of a first mobile terminal performed based on a flight path to a first landing point, information on one or more second landing points associated with the flight path to the first landing point via a communication network; and performing landing operation at a landing scheduled point different from the first landing point according to the information on the one or more second landing points.

### Advantageous Effects of Invention

According to the present invention, the mobile terminal can land at an appropriate landing point in reaction to a change of an incident that may occur while the mobile terminal flies along a flight path. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a system 1 according to an example embodiment of the present invention;

FIG. 2 is a block diagram illustrating an example of a schematic configuration of a control apparatus 100 according to a first example embodiment;

FIG. 3 is a block diagram illustrating an example of a schematic configuration of a mobile terminal 200 according to the first example embodiment;

FIG. 4 is a diagram for schematically describing technical features of the first example embodiment;

FIG. 5 is an explanatory diagram for describing an example of flight operation of a first mobile terminal (for example, a mobile terminal 200a) based on a flight path to a first landing point;

FIG. 6 is a diagram illustrating a specific example of a plurality of zones 61 allocated by a flight airspace 60 managed by the control apparatus 100;

FIG. 7 is a diagram for describing an example of a flow of landing operation of the first mobile terminal according to instruction of flight cancellation from the control apparatus 100;

FIG. 8 is a diagram for describing an example of a flow of landing operation of the first mobile terminal (mobile terminal 200a) according to disconnection of communication between the control apparatus 100 and the first mobile terminal (mobile terminal 200a);

FIG. 9 is a diagram for describing a flow of a first operation example of the landing operation performed by the first mobile terminal (mobile terminal 200a);

FIG. 10 is a diagram for describing a flow of a second operation example of the landing operation performed by the first mobile terminal (mobile terminal 200a); and

FIG. 11 is an explanatory diagram illustrating an example of a schematic configuration of a system 2 according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of Present Invention

2. Configuration of System

3. First Example Embodiment
3.1. Configuration of Control Apparatus 100
3.2. Configuration of Mobile Terminal 200
3.3. Technical Features

4. Second Example Embodiment
4.1. Configuration of System 2
4.2. Configuration of Control Apparatus 500
4.3. Configuration of First Mobile Terminal 600
4.4. Technical Features

5. Other Example Embodiments

### 1. Overview of Example Embodiments of Present Invention

First, an overview of example embodiments of the present invention will be described.

(1) Technical Issues

Mobile terminals (drone or the like) that perform flight according to information on a flight path received from a server or the like via a communication network have been widely known.

For example, PTL 1 discloses configuring of a flight route of a flight apparatus based on a radio resource that can be allocated to a flight apparatus (mobile terminal) by a base station.

Further, PTL 2 discloses the following: when an operation administrator determines that a flight of a drone according to a flight plan is impossible, instructing a business terminal that manages the drone to carry out emergency landing (landing at an unscheduled landing point; the landing point is, for example, a riverbed, a branch office of the business operator, or the like).

Further, PTL 3 discloses the following: when it is determined that a drone is in a state capable of flying for approximately at least several minutes, transmitting, to the drone, countermeasure instruction information for guiding the drone to a landing point to allow its landing.

However, for example, in the technique disclosed in PTL 2, for example, when a mobile terminal such as a drone cannot perform flight, for example, landing instruction at a landing point such as a riverbed, a branch office of a business operator, or the like is only performed for the mobile terminal. In other words, the techniques disclosed in the above-described patent literatures and the like including PTL 2 do not enable landing at an appropriate landing point in reaction to a change of an incident that may occur while the mobile terminal flies along a flight path.

One example object of the present example embodiment is to enable the mobile terminal to land at an appropriate landing point in reaction to a change of an incident that may occur while the mobile terminal flies along a flight path.

(2) Technical Features

In the present example embodiment, for example, a control apparatus acquires, according to a flight of a first mobile terminal performed based on a flight path to a first landing point, information on one or more second landing points associated with the flight path to the first landing point, and transmits the information on the one or more second landing points to the first mobile terminal via a communication network.

In the present example embodiment, for example, a first mobile terminal receives, according to a flight of a first mobile terminal performed based on a flight path to a first landing point, information on one or more second landing points associated with the flight path to the first landing point via a communication network, and performs landing operation at a target scheduled point different from the first landing point according to the information on the one or more second landing points.

With this configuration, for example, the mobile terminal can land at an appropriate landing point in reaction to a change of an incident that may occur while the mobile terminal flies along a flight path.

Note that the technical features described above are merely a specific example of the example embodiments of the present invention, and as a matter of course, the example embodiments of the present invention are not limited to the technical features described above.

### 2. Configuration of System

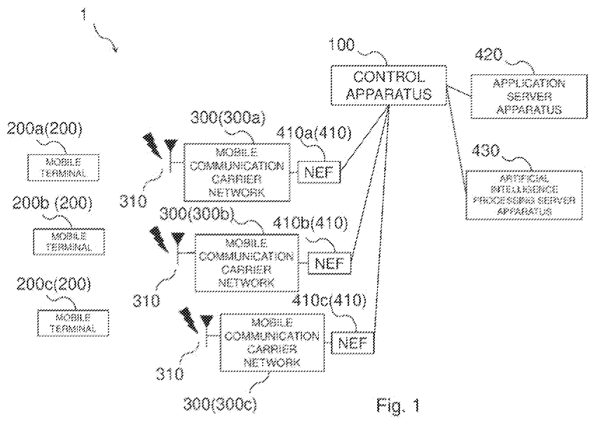

With reference to FIG. 1, an example of a configuration of a system 1 according to the example embodiments of the present invention will be described. FIG. 1 is an explanatory diagram illustrating an example of a schematic configuration of the system 1 according to the example embodiment of the present invention. With reference to FIG. 1, the system 1 includes a control apparatus 100, mobile terminals 200a, 200b, and 200c (collectively also referred to as “mobile terminal 200”), mobile communication networks 300a, 300b, and 300c (collectively referred to as “mobile communication network 300”) that are respectively managed by a plurality of mobile communication carriers, network exposure functions (NEFs) 410a, 410b, and 410c,an application server apparatus 420, and an artificial intelligence processing server apparatus 430.

(Control Apparatus 100)

For example, the control apparatus 100 performs communication with the mobile terminal 200 via the NEF 410 and the mobile communication network 300. Note that the control apparatus 100 may perform communication with the mobile terminal 200 by using not only the mobile communication network 300 managed by the mobile communication carrier but also any radio communication means (a satellite communication network or the like).

(Mobile Terminal 200)

The mobile terminal 200 is, for example, a terminal apparatus such as an unmanned drone and a manned drone that performs flight according to information on a flight path received from the control apparatus 100. For example, each of the mobile terminals 200a, 200b, and 200c may perform communication with any of the mobile communication networks 300a, 300b, and 300c.

(Mobile Communication Network 300)

The mobile communication network 300 is a network managed by respective mobile communication carriers as described above, for example, and is a network conforming to standards/specifications of the Third Generation Partnership Project (3GPP). More specifically, for example, the mobile communication network 300 may be a network conforming to standards/specifications of LTE/LTE-Advanced and/or System Architecture Evolution (SAE). Alternatively, the mobile communication network 300 may be a network conforming to standards/specifications of the fifth generation (5G)/New Radio (NR). The mobile communication network 300 includes, for example, a radio access network 310, and wirelessly performs communication with the mobile terminal 200 through the radio access network 310. As a matter of course, the mobile communication network 300 includes a core network higher than the radio access network 310.

(Application Server Apparatus 420 and Artificial Intelligence Processing Server Apparatus 430)

The application server apparatus 420 and the artificial intelligence processing server apparatus 430 provide various pieces of information to the control apparatus 100. For example, the application server apparatus 420 may execute a flight application that a business operator managing the mobile terminal 200 performs remote operation. The application server apparatus 420 may, for example, acquire weather information of a flight airspace managed by the control apparatus 100, and provide the weather information to the control apparatus 100 at any timing.

### 3. First Example Embodiment

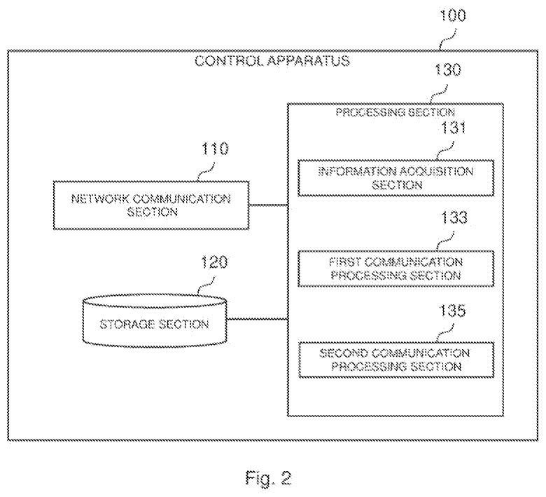

Next, with reference to FIG. 2 to FIG. 10, a first example embodiment according to the present invention will be described.

<3.1. Configuration of Control Apparatus 100>

Next, with reference to FIG. 2, an example of a configuration of the control apparatus 100 according to the first example embodiment will be described. FIG. 2 is a block diagram illustrating an example of a schematic configuration of the control apparatus 100 according to the first example embodiment. With reference to FIG. 2, the control apparatus 100 includes a network communication section 110, a storage section 120, and a processing section 130.

(1) Network Communication Section 110

The network communication section 110 receives a signal from a network and transmits a signal to the network.

(2) Storage Section 120

The storage section 120 temporarily or permanently stores a program (instructions) and parameters for operations of the control apparatus 100 as well as various data. The program includes one or more instructions for the operations of the control apparatus 100.

(3) Processing Section 130

The processing section 130 provides various functions of the control apparatus 100. The processing section 130 includes an information acquisition section 131, a first communication processing section 133, and a second communication processing section 135. Note that the processing section 130 may further include constituent elements other than these constituent elements. In other words, the processing section 130 may also perform operations other than the operations of these constituent elements. Concrete operations of the information acquisition section 131, the first communication processing section 133, and the second communication processing section 135 will be described later in detail.

For example, the processing section 130 (first communication processing section 133) communicates with the mobile communication network 300 via the network communication section 110, and with the mobile terminal 200 via the mobile communication network 300. The processing section 130 (second communication processing section 135) communicates with the application server apparatus 420, the artificial intelligence processing server apparatus 430, and the like via the network communication section 110.

(4) Implementation Example

The network communication section 110 may be implemented with a network adapter and/or a network interface card, and the like. The storage section 120 may be implemented with a memory (e.g., a nonvolatile memory and/or a volatile memory) and/or a hard disk, and the like. The processing section 130 may be implemented with one or more processors. The information acquisition section 131, the first communication processing section 133, and the second communication processing section 135 may be implemented with the same processor or may be implemented with separate processors. The memory (storage section 120) may be included in the one or more processors or may be provided outside the one or more processors.

The control apparatus 100 may include a memory configured to store a program (instructions) and one or more processors that can execute the program (instructions). The one or more processors may execute the program and thereby perform operations of the processing section 130 (operations of the information acquisition section 131, the first communication processing section 133, and/or the second communication processing section 135). The program may be a program for causing the processor(s) to execute the operations of the processing section 130 (operations of the information acquisition section 131, the first communication processing section 133, and/or the second communication processing section 135).

Note that the control apparatus 100 may be virtual. In other words, the control apparatus 100 may be implemented as a virtual machine. In this case, the control apparatus 100 (the virtual machine) may operate as a physical machine (hardware) including a processor, a memory, and the like, and a virtual machine on a hypervisor.

<3.2. Configuration of Mobile Terminal 200>

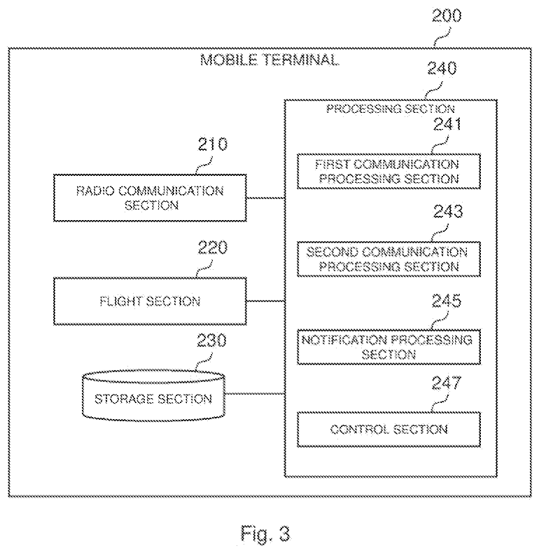

Next, with reference to FIG. 3, an example of a configuration of the mobile terminal 200 according to the first example embodiment will be described. FIG. 3 is a block diagram illustrating an example of a schematic configuration of the mobile terminal 200 according to the first example embodiment. With reference to FIG. 3, the mobile terminal 200 includes a radio communication section 210, a flight section 220, a storage section 230, and a processing section 240.

(1) Radio Communication Section 210

The radio communication section 210 wirelessly transmits and/or receives a signal. For example, the radio communication section 210 receives a signal from the radio access network 310 (for example, radio station) included in the mobile communication network 300, and transmits a signal to the radio access network 310.

(2) Flight Section 220

The flight section 220 includes a rotor, a driving means, and the like, and causes the mobile terminal 200 to fly.

(3) Storage Section 230

The storage section 230 temporarily or permanently stores a program (instructions) and parameters for operations of the mobile terminal 200 as well as various data. The program includes one or more instructions for the operations of the mobile terminal 200.

(4) Processing Section 240

The processing section 240 provides various functions of the mobile terminal 200. The processing section 240 includes a first communication processing section 241, a second communication processing section 243, a notification processing section 245, and a control section 247. Note that the processing section 240 may further include constituent elements other than these constituent elements. In other words, the processing section 240 may also perform operations other than the operations of these constituent elements. Concrete operations of the first communication processing section 241, the second communication processing section 243, the notification processing section 245, and the control section 247 will be described later in detail.

For example, the processing section 240 (first communication processing section 241) communicates with the mobile communication network 300 via the radio communication section 210. The processing section 240 (second communication processing section 243) performs inter-terminal (Device to Device (D2D)) communication with another mobile terminal 200 via the radio communication section 210. In addition, the processing section 240 (control section 247) controls the flight section 220 and performs flight of the mobile terminal 200.

(5) Implementation Example

The radio communication section 210 may be implemented with an antenna, a radio frequency (RF) circuit, and the like, and the antenna may be a directional antenna. The flight section 220 is implemented with a rotor, a drive circuit that rotationally drives the rotor, a battery that supplies power to the drive circuit, and the like. The storage section 230 may be implemented with a memory (e.g., a nonvolatile memory and/or a volatile memory) and/or a hard disk, and the like. The processing section 240 may be implemented with one or more processors, such as a baseband (BB) processor and/or a different kind of processor. The first communication processing section 241, the second communication processing section 243, the notification processing section 245, and the control section 247 may be implemented with the same processor or may be implemented with separate processors. The memory (storage section 230) may be included in the one or more processors or may be provided outside the one or more processors. As an example, the processing section 240 may be implemented in a System on Chip (SoC).

The mobile terminal 200 may include a memory configured to store a program (instructions) and one or more processors that can execute the program (instructions). The one or more processors may perform operations of the processing section 240 (operations of the first communication processing section 241, the second communication processing section 243, the notification processing section 245, and/or the control section 247) by executing the program. The program may be a program for causing the processor(s) to execute the operations of the processing section 130 (operations of the information acquisition section 131, the first communication processing section 133, and/or the second communication processing section 135).

<3.3. Technical Features>

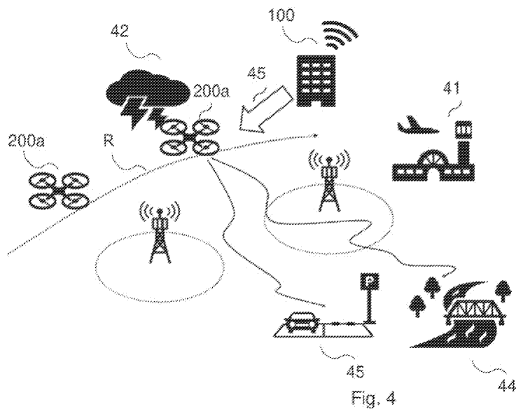

With reference to FIG. 4 to FIG. 10, technical features of the first example embodiment will be described.

According to the first example embodiment, the control apparatus 100 (information acquisition section 131) acquires, according to a flight of the first mobile terminal (for example, the mobile terminal 200a) performed based on a flight path to a first landing point, information on one or more second landing points associated with the flight path to the first landing point. The control apparatus 100 (first communication processing section 133) transmits the information on the one or more second landing points to the first mobile terminal (for example, the mobile terminal 200a) via the communication network (for example, the mobile communication network 300).

According to the first example embodiment, the first mobile terminal (for example, the first communication processing section 241 of the mobile terminal 200a) receives, according to a flight of the first mobile terminal (for example, the mobile terminal 200a) performed based on the flight path to the first landing point, information on one or more second landing points associated with the flight path to the first landing point via the communication network (for example, the mobile communication network 300). The first mobile terminal (for example, the control section 247 of the mobile terminal 200a) performs landing operation at a target scheduled point different from the first landing point according to the information on the one or more second landing points.

FIG. 4 is a diagram for schematically describing technical features of the first example embodiment. With reference to FIG. 4, for example, when it is expected that the mobile terminal 200a performing flight to a first landing point 41 is to pass through a thunder forecast area 42, the control apparatus 100 (information acquisition section 131) transmits, to the mobile terminal 200a, information (information transmitted by an arrow 45 in FIG. 4) on second landing points 43 and 44 associated with a flight path R to the first landing point 41. Subsequently, the mobile terminal 200a starts landing operation at one of the second landing points 43 and 44, and can thereby avoid passing through the thunder forecast area 42.

(1) The Flight Path to the First Landing point

The flight path to the first landing point is, for example, a flight path configured by the control apparatus 100 according to a flight request from the first mobile terminal (for example, the mobile terminal 200a), a management server (for example, the application server apparatus 420) that manages the first mobile terminal (for example, the mobile terminal 200a), or the like.

For example, a flight path from a take-off scheduled point of the first mobile terminal (for example, the mobile terminal 200a) to the first landing point is configured for the control apparatus 100. When the flight path is configured by the control apparatus 100, information on the flight path is transmitted to the first mobile terminal (for example, the mobile terminal 200a) via the mobile communication network 300. The mobile communication network 300 with which the first mobile terminal (for example, the mobile terminal 200a) wirelessly communicates configures a radio resource for the flight of the first mobile terminal (for example, the mobile terminal 200a).

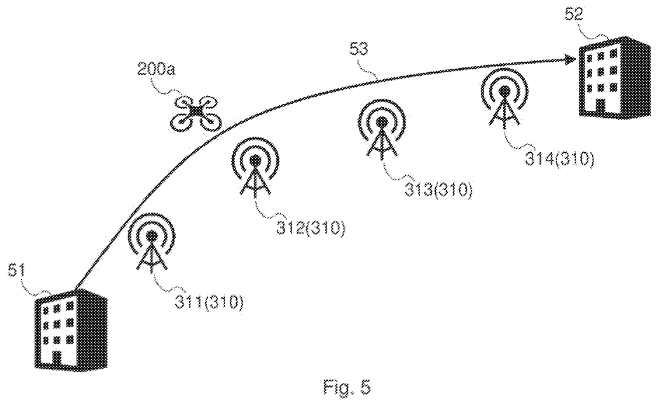

FIG. 5 is an explanatory diagram for describing an example of flight operation of the first mobile terminal (for example, the mobile terminal 200a) based on the flight path to the first landing point. With reference to FIG. 5, for example, the radio access network 310 allocates a radio resource for the mobile terminal 200a to fly along the flight path R to four radio stations 311, 312, 313, and 314 whose coverage areas are configured on a flight path 53 from a take-off scheduled point 51 to a first landing point 52. The radio resource is, specifically, a frequency time domain resource secured by each of the radio stations 311, 312, 313, and 314 to perform radio communication with the mobile terminal 200a. For the mobile terminal 200a, each of the radio stations 311, 312, 313, and 314 secures as many frequency time domain resources as necessary for the mobile terminal 200a to perform flight while the mobile terminal 200a exists in the coverage area, for example. In this manner, as illustrated in FIG. 5, the mobile terminal 200a transmits and/or receives information (for example, position information of the mobile terminal 200a, remaining battery information of the mobile terminal 200a, instruction information from the control apparatus 100, or the like) with the control apparatus 100 via each of the radio stations in order of the radio stations 311, 312, 313, and 314, and can thereby perform flight along the flight path 53.

Configuration of Flight Path Based on Zone

The flight path for flying to the first landing point may be configured based on a plurality of zones capable of identifying a three-dimensional space in common among the mobile communication networks 300a, 300b, and 300c managed by a plurality of mobile communication carriers performing radio communication with the mobile terminal (for example, the mobile terminals 200a, 200b, and 200c).

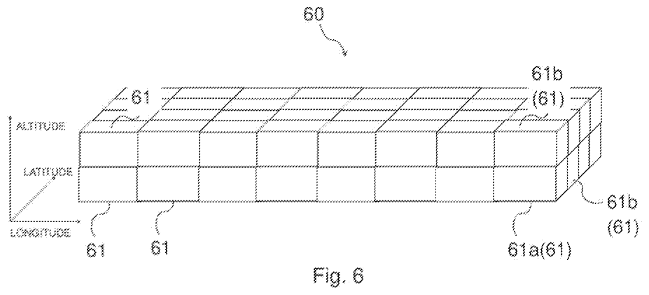

FIG. 6 is a diagram illustrating a specific example of a plurality of zones 61 allocated by a flight airspace 60 managed by the control apparatus 100. The zone 61 is, for example, a three-dimensional space identified by latitude, longitude, and altitude. As a specific example, a region in which the flight airspace 60 is identified with (X+3) minutes from 35 degrees X minutes north latitude, (Y+7) minutes from 139 degrees Y minutes east longitude, and altitude of 150 m or less is assumed (X and Y are any positive number). In this case, for example, the control apparatus 100 allocates a total of 64 zones. In other words, four different zones are allocated in the unit of minutes in the latitude direction, eight different zones are allocated in the unit of minutes in the longitude direction, and two different zones are allocated in the unit of 75 m in the altitude direction.

For example, a zone 61a at 35 degrees X minutes north latitude, 139 degrees (Y+7) minutes east longitude, and altitude of 0 to 75 m is considered. In this case, adjacent zones in the latitude direction and the altitude direction correspond to zones 61b and 61c, respectively.

The control apparatus 100 manages the number of mobile terminals that can pass per unit time for each zone 61, and can thereby appropriately manage the flight path of each of the mobile terminals (for example, the mobile terminals 200a, 200b, and 200c) communicated and connected with different mobile communication networks 300.

The control apparatus 100 may manage the number of mobile terminals that can pass per unit time based on the flight direction of the mobile terminals for each zone 61. For example, when the mobile terminals passing through the zone 61 fly and pass from every direction, the number of mobile terminals that can pass per unit time may be configured to a relatively small number (for example, a number smaller than a predetermined threshold). In contrast, in a case of a flight in which the directions of the mobile terminals passing through the zone 61 are fixed, for example, all of the mobile terminals fly from the south and head for the north, the number of mobile terminals that can pass per unit time may be configured to a relatively large number (for example, a number equal to or larger than the predetermined threshold).

The control apparatus 100 may manage the number of mobile terminals that can pass per unit time based on a flight speed of the mobile terminals for each zone 61. For example, the mobile terminals passing through the zone 61 pass at a low speed, for example, 30 km/H, the number of mobile terminals that can pass per unit time may be configured to a relatively large number (for example, a number equal to or larger than a predetermined threshold). In contrast, when the mobile terminals passing through the zone 61 pass at a high speed, for example 100 km/H, the number of mobile terminals that can pass per unit time may be configured to a relatively small number (for example, a number smaller than the predetermined threshold).

Information on the zone 61 is notified from the control apparatus 100 to each of the mobile communication networks 300. The example illustrated in FIG. 6 is considered. As information on the zone 61, the control apparatus 100 notifies each of the mobile communication networks 300 of information on the flight airspace 60 identified with latitude, longitude, and altitude, the number (for example, 64 ) of zones allocated in the flight airspace 60, and an allocation standard (the unit of minutes, the unit of the altitude of 75 m, or the like).

As the information on the zone 61, the control apparatus 100 may transmit information (identifiers of the zones or the like) for identifying each of the zones 61 in the flight airspace 60 to each of the mobile communication networks 300.

Each of the mobile communication networks 300 associates, for example, the zone 61 notified from the control apparatus 100 with a tracking area managed for each of the mobile communication networks 300 in advance, and can thereby easily identify the radio station whose coverage area is present on the flight path to the first landing point. The zone 61 may correspond to one tracking area, or may correspond to a plurality of tracking areas. A plurality of zones 61 may correspond to one tracking area.

(2) The Information on the Second Landing Point

The information on the one or more second landing points is, for example, associated with the flight path for flying to the first landing point in the following example aspects.

Association Based on Distance

For example, the one or more second landing points may be present at or within a predetermined distance (for example, 1 km from the flight path) from the flight path for flying to the first landing point. With the one or more second landing points being present at or within a predetermined distance from the flight path as described above, the first mobile terminal (for example, the mobile terminal 200a) can be caused to promptly land in reaction to a change of an incident that has occurred on the flight path (for example, a change of a weather condition that may suddenly occur or the like).

Association Based on Zone

For example, when the flight path is configured based on the zone as described above, the one or more second landing points may be point(s) identified based on one or more zones to which the flight path to the first landing point belongs. Specifically, the one or more second landing points may be, for example, identified as being present immediately under the same zone as that to which the flight path belongs or its adjacent zone. With this, the control apparatus 100 can, for example, manage the number of mobile terminals to be caused to land at the one or more second landing points for each zone.

Specific Example of Second Landing Point Information

The one or more second landing points may be information acquired according to information on an operation state of the first mobile terminal (for example, the mobile terminal 200a). Specifically, the information on the operation state of the first mobile terminal (for example, the mobile terminal 200a) is, for example, information, such as remaining battery, internal temperature, and power consumption, that may be transmitted from the first mobile terminal (for example, the mobile terminal 200a). In other words, the control apparatus 100 (for example, the information acquisition section 131) configures the second landing point according to the remaining battery that may be transmitted from the first mobile terminal (for example, the mobile terminal 200a), for example, and thereby acquires the second landing point. For example, a point closer to the flight path is preferentially configured for the second landing point as the remaining battery of the first mobile terminal (for example, the mobile terminal 200a) is less.

The one or more second landing points may be information acquired according to information on a condition of the flight path to the first landing point. Specifically, the information on the condition of the flight path to the first landing point is, for example, weather information provided from the application server apparatus 420 or the like. In other words, the control apparatus 100 may configure the second landing point suitable for the mobile terminal 200, based on weather information provided from the application server apparatus 420 or the like. For example, the second landing point may exclude the thunder forecast area identified based on the weather information from the configuration of the second landing point. For example, the second landing point may be preferentially configured in view of wind direction and wind speed identified based on the weather information.

The one or more second landing points may be information acquired according to information on a type of the first mobile terminal (for example, the mobile terminal 200a). Specifically, the information on the type of the first mobile terminal (for example, the mobile terminal 200a) corresponds to, for example, an attribute classified according to an application (a delivery service, a taxi) or the like of the mobile terminal. As an example, when there are two types, i.e., a delivery service and a taxi, the control apparatus 100 (for example, the information acquisition section 131) may configure the second landing point as follows, for example, according to the information on the type of the mobile terminal 200 that may be transmitted from the mobile terminal 200. For example, when the type of the mobile terminal 200 corresponds to the “delivery service”, a relatively narrow place such as a vacant lot may be configured as the second landing point. In contrast, when the type of the mobile terminal 200 corresponds to the “taxi”, the second landing point may be configured only to a relative wide place such as a ground of a school.

Plurality of Second Landing Points

The information on the one or more second landing points may be information on a plurality of second landing points. In this case, for example, the first mobile terminal (for example, the control section 247 of the mobile terminal 200a) determines the landing scheduled point out of the plurality of second landing points, based on the current position of the first mobile terminal (for example, the mobile terminal 200a). For example, the second landing point closest to the current position out of the plurality of second landing points may be determined as the landing scheduled point. When communication between the first mobile terminal (for example, the mobile terminal 200a) and the mobile communication network 300 is disconnected, for example, the first mobile terminal (for example, the control section 247 of the mobile terminal 200a) may determine that the second landing point located in a cell (cell provided by the radio station) with which the first mobile terminal (for example, the mobile terminal 200a) was last communicated as the landing scheduled point.

Priority

Regarding each of the second landing points, priority for the first mobile terminal (for example, the mobile terminal 200a) to preferentially land may be configured.

(Operation Performed by Control Apparatus 100)

For example, the information on the plurality of second landing points may include information indicating priority for the first mobile terminal (for example, the mobile terminal 200a) to preferentially land for each of the second landing points. In other words, the control apparatus 100 (first communication processing section 133) may transmit the information indicating the priority to the first mobile terminal (for example, the mobile terminal 200a).

In particular, the information indicating the priority may be information acquired according to the information on the type of the mobile terminal. For example, the control apparatus 100 (information acquisition section 131) may configure the priority according to the type of the first mobile terminal (for example, the mobile terminal 200a), and thereby acquire the information indicating the priority.

For example, when the type of the first mobile terminal (for example, the mobile terminal 200a) corresponds to the “delivery service”, the priority may be configured as follows. For example, as the second landing point corresponding to the first priority, a private place, such as the property of a company managing the first mobile terminal (for example, the mobile terminal 200a), is configured. As the second landing point corresponding to the second priority, for example, a public place, such as a park and a riverbed, is configured. As the second landing point corresponding to the third priority, for example, a place in which the first mobile terminal (for example, the mobile terminal 200a) can land even though articles to be delivered are damaged or lost, such as a river, the ocean, or in the mountains, is configured.

When the type of the first mobile terminal (for example, the mobile terminal 200a) corresponds to the “taxi”, the priority may be configured as follows. For example, as the second landing point corresponding to the first priority, a private place, such as the property of a company managing the first mobile terminal (for example, the mobile terminal 200a), is configured. As the second landing point corresponding to the second priority, a private place of an entity other than a company managing the first mobile terminal (for example, the mobile terminal 200a), such as a hospital and a heliport of a large building, is configured. As the second landing point corresponding to the third priority, for example, a public place such as a park and a riverbed, is configured. As the second landing point corresponding to the fourth priority, for example, a river, the ocean, in the mountains, or the like is configured. As the second landing point corresponding to the fifth priority, for example, a place allowing landing using a parachute is configured.

(Operation Performed by the First Mobile Terminal)

The priority is not necessarily configured by the control apparatus 100. For example, the first mobile terminal (control section 247 of the mobile terminal 200a) may configure the information indicating the priority, based on the type of the first mobile terminal.

(3) Instruction of Flight Cancellation

The control apparatus 100 (first communication processing section 133) may transmit information instructing cancelation of a flight of the first mobile terminal (for example, the mobile terminal 200a) performed based on the flight path to the first landing point to the first mobile terminal (for example, the mobile terminal 200a) via the communication network (for example, the mobile communication network 300).

More specifically, the control apparatus 100 transmits the information instructing cancellation of a flight to the first mobile terminal (for example, the mobile terminal 200a) via the communication network (for example, the mobile communication network 300), based on information on a condition of the flight path to the first landing point. Here, the information on the condition of the flight path to the first landing point is, for example, information provided from the application server apparatus 420, the artificial intelligence processing server apparatus 430, or the like, such as a change of weather that may suddenly occur on the flight path.

The information on the one or more second landing points may be included in the information instructing cancellation of a flight of the first mobile terminal (for example, the mobile terminal 200a). In this manner, the landing point suitable for promptly performing of landing operation after cancellation of the flight can be notified to the first mobile terminal (for example, the mobile terminal 200a).

When the first mobile terminal (for example, the control section 247 of the mobile terminal 200a) receives the information instructing cancellation of the flight of the first mobile terminal (for example, the mobile terminal 200a) from the control apparatus 100, the first mobile terminal starts landing operation at the landing scheduled point.

When the control apparatus 100 instructs cancellation of the flight, information on an emergency alert (for example, information on a weather change) or the like may be distributed from the radio access network (for example, the radio access network 310) present on a communication path between the control apparatus 100 and the first mobile terminal (mobile terminal 200a) to the first mobile terminal (for example, the mobile terminal 200a) and the mobile terminals (for example, the mobile terminals 200b and 200c) flying in the surrounding area by using the Public Warning System (PWS) or the Cell Broadcast Service (CBS). The PWS may be, for example, any one of the Earthquake and Tsunami Warning System (ETWS), the Commercial Mobile Alert System (CMAS), the Korean Public Alert System (KPAS), and EU Alert.

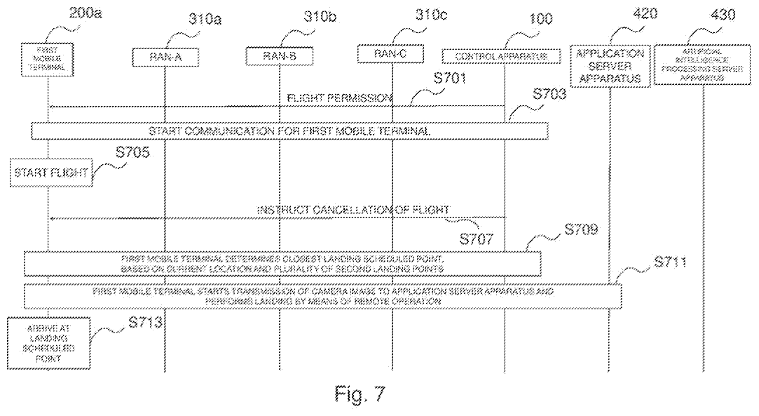

Operation Example FIG. 7 is a diagram for describing an example of a flow of the landing operation of the first mobile terminal according to the instruction of flight cancellation from the control apparatus 100. In the example illustrated in FIG. 7, for example, the first mobile terminal (mobile terminal 200a) is communicably connected to the control apparatus 100 via one of three radio access networks (RANs) 310a, 310b, and 310c in the mobile communication network 300.

First, with reference to FIG. 7, the control apparatus 100 transmits information instructing flight permission to the first mobile terminal (mobile terminal 200a) (S701). The information instructing the flight permission includes, for example, information indicating the flight path to the first landing point, radio information used by the first mobile terminal (mobile terminal 200a) for a flight along the flight path, and information on the plurality of second landing points.

Next, the control apparatus 100 starts communication for the first mobile terminal (mobile terminal 200a) to perform flight (S703). Next, the first mobile terminal (mobile terminal 200a) takes off from the current position and starts flight (S705).

Next, the control apparatus 100 transmits information instructing cancellation of the flight of the first mobile terminal (mobile terminal 200a) to the first mobile terminal (mobile terminal 200a) (S707). Note that, when a certain number of mobile terminals or more perform flight near the first mobile terminal (mobile terminal 200a), the control apparatus 100 may configure a predetermined standby time, based on hovering capability (for example, information that may be obtained from the remaining battery or the like) of the first mobile terminal (mobile terminal 200a). In this case, the control apparatus 100 may transmit the information instructing cancellation of the flight of the first mobile terminal (mobile terminal 200a) after the elapse of the standby time. When the control apparatus 100 instructs the first mobile terminal (mobile terminal 200a) to standby, it means that the first mobile terminal (mobile terminal 200a) exists in the zone in which the first mobile terminal (mobile terminal 200a) exists for scheduled time or longer. In order to secure safety of the entire flight region, the control apparatus 100 may perform instruction of cancellation of a flight or changes of a flight path to the mobile terminals in the zone as well as other zones.

The information instructing cancellation of the flight includes information on the plurality of second landing points, a change instruction on operation related to the flight, and a flight number normalized for each mobile terminal (flight management number managed by the control apparatus 100). Here, the information on the plurality of second landing points may be different from at least a part of the information on the second landing point transmitted at the time of flight permission.

Next, the first mobile terminal (mobile terminal 200a) determines the closest landing scheduled point, based on the current position and the plurality of second landing points (S709). Next, the first mobile terminal (mobile terminal 200a) starts transmission of a camera image to the application server apparatus 420 and performs landing by means of remote operation (S711). Subsequently, the first mobile terminal (mobile terminal 200a) arrives at the landing scheduled point (S713). When the mobile terminal (mobile terminal 200a) arrives at the landing scheduled point, the mobile terminal (mobile terminal 200a) may notify the control apparatus 100 of arrival point, arrival time, information of the mobile terminal (mobile terminal 200a) at the time of arrival, and information on the surroundings of the landing scheduled point.

According to the operation illustrated in FIG. 7 described above, the first mobile terminal (mobile terminal 200a) can land at an appropriate landing scheduled point according to the information instructing cancellation of the flight.

(4) Landing Operation according to Disconnection of Communication

For example, when communication via the communication network (mobile communication network 300) by the mobile terminal 200 is disconnected, the mobile terminal 200 (control section 247) may start landing operation at the landing scheduled point. Specifically, when communication with any network node present on a communication path between the mobile terminal 200 and the control apparatus 100 is disconnected, or when deterioration of radio quality in the mobile terminal 200 is detected, the mobile terminal 200 (control section 247) may start the landing operation at the landing scheduled point.

Operation Example

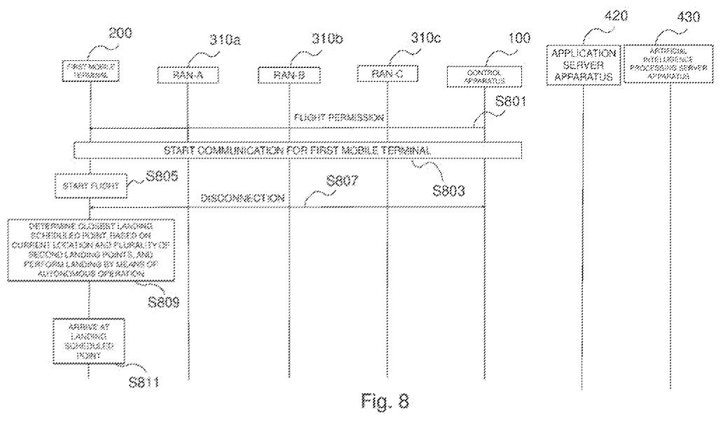

FIG. 8 is a diagram for describing an example of a flow of the landing operation of the first mobile terminal (mobile terminal 200a) according to disconnection of communication between the control apparatus 100 and the first mobile terminal (mobile terminal 200a). In the example illustrated in FIG. 8, for example, the first mobile terminal (mobile terminal 200a) is communicably connected to the control apparatus 100 via one of three radio access networks (RANs) 310a, 310b, and 310c in the mobile communication network 300.

First, with reference to FIG. 8, the control apparatus 100 transmits information instructing flight permission to the first mobile terminal (mobile terminal 200a) (S801). The information instructing the flight permission includes, for example, information indicating the flight path to the first mobile terminal (mobile terminal 200a), radio information used by the first mobile terminal (mobile terminal 200a) for a flight along the flight path, and information on the plurality of second landing points.

Next, the control apparatus 100 starts communication for the first mobile terminal (mobile terminal 200a) to perform flight (S803). Next, the first mobile terminal (mobile terminal 200a) takes off from the current position and starts flight (S805).

Next, the first mobile terminal (mobile terminal 200a) disconnects communication with the control apparatus 100 (S807). The disconnection of communication includes, for example, a failure of handover, detection of a radio link failure (RLF), failure of reconnection (RRC re-establishment) of radio resource control (RRC), and the like with one or more radio stations with which the first mobile terminal (mobile terminal 200a) communicates.

Next, the first mobile terminal (mobile terminal 200a) determines the closest landing scheduled point, based on the current position and the plurality of second landing points, and performs landing toward the landing scheduled point by means of autonomous operation (S809). Subsequently, the first mobile terminal (mobile terminal 200a) arrives at the landing scheduled point (S811).

According to the operation example illustrated in FIG. 8 described above, for example, the first mobile terminal (mobile terminal 200a) receives the information on the plurality of second landing points in advance before the communication with the control apparatus 100 is disconnected such as at the time of flight permission, and can thus appropriately perform landing based on the information on the plurality of second landing points.

(5) Landing Operation according to Inter-Terminal Communication

When communication via the communication network (for example, the mobile communication network 300) by the first mobile terminal (for example, the mobile terminal 200a) is disconnected, the first mobile terminal (for example, the notification processing section 245 of the mobile terminal 200a) may notify one or more second mobile terminals (for example, the mobile terminals 200b and 200c) of information on the landing scheduled point. Here, the one or more second mobile terminals (for example, the mobile terminals 200b and 200c) are, for example, mobile terminals that can perform inter-terminal communication with the first mobile terminal (for example, the mobile terminal 200a), and exist in, for example, the same cell as that of the first mobile terminal (for example, the mobile terminal 200a) or its adjacent cell or the same zone as that of the first mobile terminal (for example, the mobile terminal 200a) or its adjacent zone.

The first mobile terminal (for example, the second communication processing section 243 of the mobile terminal 200a) may receive, from the one or more second mobile terminals (for example, the mobile terminals 200b and 200c), information on the landing scheduled point at which the one or more second mobile terminals (for example, the mobile terminals 200b and 200c) perform landing. In this case, the first mobile terminal (for example, the control section 247 of the mobile terminal 200a) may change the landing scheduled point at which the first mobile terminal (for example, the mobile terminal 200a) perform landing according to the information on the landing scheduled point at which the one or more second mobile terminals (for example, the mobile terminals 200b and 200c) perform landing.

Specifically, when the landing scheduled point at which the one or more second mobile terminals (for example, the mobile terminals 200b and 200c) perform landing is the same as the landing scheduled point determined by the first mobile terminal (for example, the mobile terminal 200a) or is close thereto (at or within a predetermined distance), the first mobile terminal (for example, the control section 247 of the mobile terminal 200a) executes processing for avoiding collision with the one or more second mobile terminals (for example, the mobile terminals 200b and 200c).

For example, in order to avoid collision with the one or more second mobile terminals (for example, the mobile terminals 200b and 200c), for example, the first mobile terminal (for example, the mobile terminal 200a) shares information such as the priority of the mobile terminals configured in advance by the control apparatus 100 or the like, the priority of the mobile terminals generated by a random function or the like, and time required before landing performed by each mobile terminal, with the one or more second mobile terminals (for example, the mobile terminals 200b and 200c), and changes the landing scheduled point at which the first mobile terminal (for example, the mobile terminal 200a) performs landing through negotiation based on these pieces of information (transmission and/or reception of the information).

When the landing scheduled point is not a point but is a range having a certain area, the first mobile terminal (for example, the mobile terminal 200a) may change the landing scheduled point to a finer range through negotiation with the one or more second mobile terminals (for example, the mobile terminals 200b and 200c), and thereby configure the landing scheduled point at which the first mobile terminal (for example, the mobile terminal 200a) performs landing to a point different from the landing scheduled point of the second mobile terminal.

The first mobile terminal (for example, the mobile terminal 200a) may share the size of the terminals, the area of a place necessary for landing, or the like with the one or more second mobile terminals (for example, the mobile terminals 200b and 200c) through negotiation with the one or more second mobile terminals (for example, the mobile terminals 200b and 200c).

### OPERATION EXAMPLE

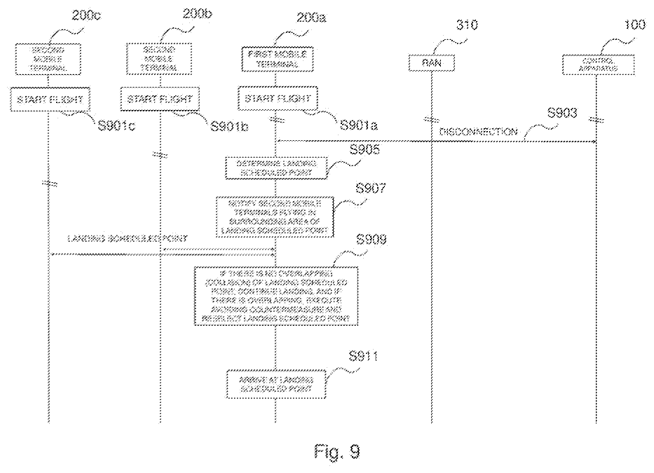

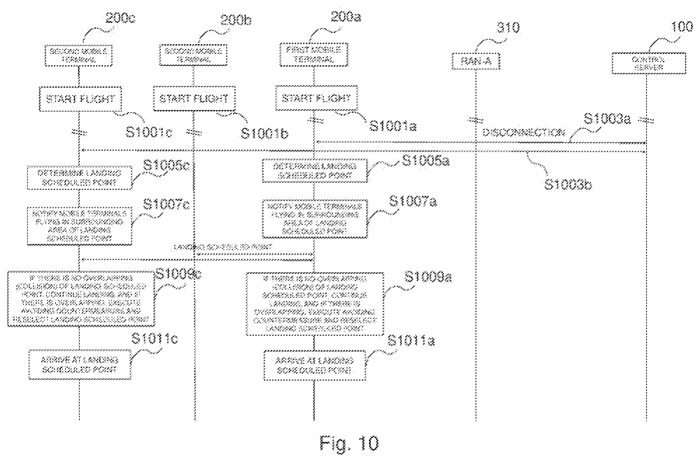

Next, with reference to FIG. 9 and FIG. 10, the landing operation performed by the first mobile terminal (mobile terminal 200a) will be described.

### First Operation Example

FIG. 9 is a diagram for describing a flow of a first operation example of the landing operation performed by the first mobile terminal (mobile terminal 200a). In the example illustrated in FIG. 9, for example, the first mobile terminal (mobile terminal 200a) and the second mobile terminals (mobile terminals 200b and 200c) fly under control of the control apparatus 100. For example, the first mobile terminal (mobile terminal 200a) is communicably connected to the control apparatus 100 via the radio access network 310.

First, with reference to FIG. 9, the first mobile terminal (mobile terminal 200a) and the second mobile terminals (mobile terminals 200b and 200c) each start a flight along the flight path under control of the control apparatus 100 (S901a, S901b, and S901c).

Next, when the communication established with the control apparatus 100 is disconnected (S903), for example, the first mobile terminal (mobile terminal 200a) determines the landing scheduled point, based on information on the second landing point (S905). Next, the first mobile terminal (mobile terminal 200a) notifies the second mobile terminals (mobile terminals 200b and 200c) flying in the surrounding area of information (landing information) on the landing scheduled point (S907). At substantially the same timing, the first mobile terminal (mobile terminal 200a) receives, from the second mobile terminals (mobile terminals 200b and 200c) flying in the surrounding area, the information on the landing scheduled point at which the second mobile terminals (mobile terminals 200b and 200c) perform landing.

An example of a communication method of the first mobile terminal (mobile terminal 200a) and the second mobile terminals (mobile terminals 200b and 200c) flying in the surrounding area will be described. When communication established with the control apparatus 100 is disconnected (S903), the first mobile terminal (mobile terminal 200a) performs securement of communication with the second mobile terminals (mobile terminals 200b and 200c) flying in the surrounding area. In this case, the first mobile terminal (mobile terminal 200a) and the second mobile terminals (mobile terminals 200b and 200c) execute proximity communication. The first mobile terminal (mobile terminal 200a) may detect the second mobile terminals (mobile terminals 200b and 200c) by using the device discovery function defined by 3GPP. In addition, the first mobile terminal (mobile terminal 200a) and the second mobile terminals (mobile terminals 200b and 200c) may communicate by using a unicast, groupcast, or broadcast communication method using the sidelink defined by 3GPP. In this case, the control apparatus 100 may enable proximity communication by notifying the first mobile terminal (mobile terminal 200a) and the second mobile terminals (mobile terminals 200b and 200c) of the same Group ID and/or Group IP multicast address and/or Temporary Mobile Group Identity (TMGI) and/or ProSe Group ID and/or ProSe Layer 2 Group ID.

Next, if there is no overlapping of the landing scheduled point, the first mobile terminal (mobile terminal 200a) continues landing, and if there is overlapping, the first mobile terminal (mobile terminal 200a) executes processing for avoiding collision and reselects the landing scheduled point (S909). Subsequently, the first mobile terminal (mobile terminal 200a) arrives at the landing scheduled point (S911).

According to the operation example illustrated in FIG. 9 described above, the first mobile terminal (mobile terminal 200a) can land at an appropriate landing scheduled point while avoiding collision or the like in cooperation with the second mobile terminals (mobile terminals 200b and 200c) flying in the surrounding area.

As an example alteration of the first operation example, the first mobile terminal (mobile terminal 200a) and the second mobile terminals (mobile terminals 200b and 200c) may perform proximity communication during the flight. In this case, when communication established with the control apparatus 100 is disconnected (S903), the first mobile terminal (mobile terminal 200a) may perform communication with the control apparatus 100 via the second mobile terminals (mobile terminals 200b and 200c). This mode of communication may use Sidelink Communication via ProSe UE-to-Network Relay capability defined by 3GPP. In that case, the second mobile terminals (mobile terminals 200b and 200c) relays communication between the first mobile terminal (mobile terminal 200a) and the control apparatus 100.

When the first mobile terminal (mobile terminal 200a) and the control apparatus 100 become capable of communication via the second mobile terminals (mobile terminals 200b and 200c), landing by means of autonomous control of the first mobile terminal (mobile terminal 200a) as in the example illustrated in FIG. 9 need not necessarily be performed, and landing in cooperation with the control apparatus 100 as in the example illustrated in FIG. 7 may be performed.

### Second Operation Example

FIG. 10 is a diagram for describing a flow of a second operation example of the landing operation performed by the first mobile terminal (mobile terminal 200a). In the example illustrated in FIG. 10, for example, the first mobile terminal (mobile terminal 200a) and the second mobile terminals (mobile terminals 200b and 200c) fly under control of the control apparatus 100. For example, the first mobile terminal (mobile terminal 200a) is communicably connected to the control apparatus 100 via the radio access network 310.

First, with reference to FIG. 10, the first mobile terminal (mobile terminal 200a) and the second mobile terminals (mobile terminals 200b and 200c) each start a flight along the flight path under control of the control apparatus 100 (S1001a, S1001b, and S1001c).

Next, the first mobile terminal (mobile terminal 200a) and the second mobile terminal (mobile terminal 200c) disconnect the communication established with the control apparatus 100 (51003a and 51003c).

Next, the first mobile terminal (mobile terminal 200a) and the second mobile terminal (mobile terminal 200c) each determine the landing scheduled point (51005a and 1005c). Next, the first mobile terminal (mobile terminal 200a) and the second mobile terminal (mobile terminal 200c) notify the mobile terminals flying in the surrounding area of information (landing information) on the landing scheduled point (S1005a and 1005c).

Next, if there is no overlapping of the landing scheduled point, the first mobile terminal (mobile terminal 200a) and the second mobile terminal (mobile terminal 200c) continue landing, and if there is overlapping, the first mobile terminal (mobile terminal 200a) and the second mobile terminal (mobile terminal 200c) execute processing for avoiding collision and reselect the landing scheduled point (S1009a and S1009c). Subsequently, the first mobile terminal (mobile terminal 200a) and the second mobile terminal (mobile terminal 200c) each arrive at the landing scheduled point (S1011a and S1011c).

According to the operation example illustrated in FIG. 10 described above, the first mobile terminal (mobile terminal 200a) can land at an appropriate landing scheduled point while avoiding collision or the like in cooperation with the second mobile terminal (mobile terminal 200c) performing landing operation to land at the surrounding area.

(6) Example Alterations

According to the first example embodiment, for example, the specific examples described above are not restrictive, and various alterations can be made.

For example, when all of the mobile terminals to perform control perform communication with specific mobile communication networks 300 or the like, the control apparatus 100 need not be located outside of each of the mobile communication networks 300, and may be, for example, a network node inside of a specific mobile communication network 300.

For example, the first mobile terminal (for example, the mobile terminal 200a) may issue a warning sound to the landing scheduled point while landing at the landing scheduled point. Whether or not the warning sound is issued may be, for example, configured for each of the second landing points being candidates for the landing scheduled point.

For example, when the first mobile terminal (for example, the mobile terminal 200a) lands using a parachute, the control apparatus 100 may notify, before the landing, a public safety answering point (PSAP) such as a nearby police station and fire station that the first mobile terminal (for example, the mobile terminal 200a) is to perform landing.

In addition, when the first mobile terminal (for example, the mobile terminal 200a) determines that the first mobile terminal (for example, the mobile terminal 200a) cannot land at the second landing point, the first mobile terminal (for example, the mobile terminal 200a) may select an alternative path different from the first flight path and may fly in the alternative path without performing landing. When the first mobile terminal (for example, the mobile terminal 200a) detects an RLF (or HO failure, RRC reconnection failure), the first mobile terminal (for example, the mobile terminal 200a) may attempt connection to a predetermined cell. The predetermined cell may be any one of a cell closest to the current position, a cell (cell provided by the radio station) with which the first mobile terminal (for example, the mobile terminal 200a) was last communicated, and a cell based on information on the alternative path stored (acquired) in advance. For example, the information on the alternative path may be received when flight permission is instructed from the control apparatus 100. The first mobile terminal (for example, the mobile terminal 200a) may report information on a new flight path including at least the alternative path to the control apparatus 100. In addition, the control apparatus 100 may transmit new flight path information to the first mobile terminal (for example, the mobile terminal 200a) in response to reception of the information on the new flight path. In this case, the first mobile terminal (for example, the mobile terminal 200a) may receive the new flight path information.

### 4. Second Example Embodiment

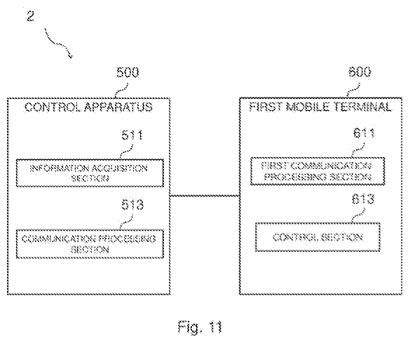

Next, with reference to FIG. 11, a second example embodiment of the present invention will be described. The above-described first example embodiment is a concrete example embodiment, whereas the second example embodiment is a more generalized example embodiment.

<4.1. Configuration of System 2>

With reference to FIG. 11, an example of a configuration of a system 2 according to the second example embodiment will be described.

FIG. 11 is an explanatory diagram illustrating an example of a schematic configuration of the system 2 according to the second example embodiment. With reference to FIG. 11, the system 2 includes a control apparatus 500 and a first mobile terminal 600.

<4.2. Configuration of Control Apparatus 500>

With reference to FIG. 11, the control apparatus 500 includes an information acquisition section 511 and a communication processing section 513. Specific operations of the information acquisition section 511 and the communication processing section 513 will be described later.

The information acquisition section 511 and the communication processing section 513 may be implemented with one or more processors, and a memory (e.g., a nonvolatile memory and/or a volatile memory), and/or a hard disk. The information acquisition section 511 and the communication processing section 513 may be implemented with the same processor or may be implemented with separate processors. The memory may be included in the one or more processors or may be provided outside the one or more processors.

The control apparatus 500 may include a memory configured to store a program (instructions) and one or more processors that can execute the program (instructions). The one or more processors may perform operations of the information acquisition section 511 and the communication processing section 513 by executing the program. The program may be a program for causing the processor(s) to execute the operations of the information acquisition section 511 and the communication processing section 513.

<4.3. Configuration of First Mobile Terminal 600>

With reference to FIG. 11, the first mobile terminal 600 includes a first communication processing section 611 and a control section 613. Specific operations of the first communication processing section 611 and the control section 613 will be described later.

The first communication processing section 611 and the control section 613 may be implemented with one or more processors, such as a baseband (BB) processor and/or a different kind of processor, a memory (e.g., a nonvolatile memory and/or a volatile memory), and/or a hard disk. The first communication processing section 611 and the control section 613 may be implemented with the same processor or may be implemented with separate processors. The memory may be included in the one or more processors or may be provided outside the one or more processors.

The first mobile terminal 600 may include a memory configured to store a program (instructions) and one or more processors that can execute the program (instructions). The one or more processors may perform operations of the first communication processing section 611 and the control section 613 by executing the program. The program may be a program for causing the processor(s) to execute the operations of the first communication processing section 611 and the control section 613.

### <4.4. Technical Features>

Technical features of the according to the second example embodiment will be described.

According to the second example embodiment, the control apparatus 500 (information acquisition section 511) acquires, according to a flight of the first mobile terminal 600 performed based on a flight path to a first landing point, information on one or more second landing points associated with the flight path to the first landing point. The control apparatus 500 (communication processing section 513) transmits the information on the one or more second landing points to the first mobile terminal 600 via a communication network.

The first mobile terminal 600 (first communication processing section 611) receives, according to a flight of the first mobile terminal 600 performed based on a flight path to a first landing point, information on one or more second landing points associated with the flight path to the first landing point via a communication network. The first mobile terminal 600 (control section 613) performs landing operation at a landing scheduled point different from the first landing point according to the information on the one or more second landing points.

Relationship with First Example Embodiment

As an example, the control apparatus 500 and the first mobile terminal 600 of the second example embodiment are the control apparatus 100 and the mobile terminal 200 of the first example embodiment, respectively. In this case, description regarding the first example embodiment may also be applied to the second example embodiment.

Note that the second example embodiment is not limited to this example.

The second example embodiment has been described above. According to the second example embodiment, the mobile terminal can land at an appropriate landing point in reaction to a change of an incident that may occur while the mobile terminal flies along a flight path.

<<5. Other Example Embodiments>>

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus (e.g., one or more apparatuses (or units) out of plurality of apparatuses (or units) constituting the control apparatus, or a module for one of the plurality of apparatuses (or units)) including constituent elements (e.g., the information acquisition section, the first communication processing section, and/or the second communication processing section) of the control apparatus described in the Specification may be provided. An apparatus (e.g., a module for the terminal apparatus) including constituent elements (e.g., the first communication processing section, the second communication processing section, the notification processing section, and/or the control section) of the mobile terminal described in the Specification may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as in the following supplementary notes, but are not limited to the following.

### (Supplementary Note 1)

A control apparatus including:

an information acquisition section configured to acquire, according to a flight of a first mobile terminal performed based on a flight path to a first landing point, information on one or more second landing points associated with the flight path to the first landing point; and

a communication processing section configured to transmit the information on the one or more second landing points to the first mobile terminal via a communication network.

### (Supplementary Note 2)

The control apparatus according to supplementary note 1, wherein

the one or more second landing points are present at or within a predetermined distance from the flight path to the first landing point.

### (Supplementary Note 3)

The control apparatus according to supplementary note 1, wherein

the flight path to the first landing point is configured based on a plurality of zones capable of identifying a three-dimensional space in common among a plurality of mobile communication networks managed by a plurality of mobile communication carriers performing radio communication with a mobile terminal, and the one or more second landing points are point(s) identified based on one or more zones to which the flight path to the first landing point belongs.

### (Supplementary Note 4)

The control apparatus according to supplementary note 3, wherein

the communication processing section is configured to transmit the information on the one or more second landing points to the first mobile terminal via a mobile communication network performing radio communication with the first mobile terminal.

### (Supplementary Note 5)

The control apparatus according to any one of supplementary notes 1 to 4, wherein

the one or more second landing points are information acquired according to information on an operation state of the first mobile terminal.

### (Supplementary Note 6)

The control apparatus according to any one of supplementary notes 1 to 5, wherein

the one or more second landing points are information acquired according to information on a condition of the flight path to the first landing point.

### (Supplementary Note 7)

The control apparatus according to any one of supplementary notes 1 to 6, wherein

the one or more second landing points are information acquired according to information on a type of the first mobile terminal.

### (Supplementary Note 8)

The control apparatus according to any one of supplementary notes 1 to 7, wherein

the information on the one or more second landing points is information on a plurality of second landing points, and

the information on the plurality of second landing points includes information indicating priority for the first mobile terminal to preferentially land for each of the plurality of second landing points.

### (Supplementary Note 9)

The control apparatus according to supplementary note 8, wherein the information indicating the priority is information acquired according to the information on a type of the first mobile terminal.

### (Supplementary Note 10)

The control apparatus according to any one of supplementary notes 1 to 9, wherein

the communication processing section is configured to transmit information instructing cancellation of the flight of the first mobile terminal performed based on the flight path to the first landing point, to the first mobile terminal via the communication network.

### (Supplementary Note 11)

The control apparatus according to supplementary note 10, wherein

the communication processing section is configured to transmit the information instructing cancellation of the flight of the first mobile terminal to the first mobile terminal via the communication network, based on information on a condition of the flight path to the first landing point.

### (Supplementary Note 12)

The control apparatus according to supplementary note 10 or 11, wherein

the information on the one or more second landing points is included in the information instructing cancellation of the flight of the first mobile terminal.

### (Supplementary Note 13)

A first mobile terminal including:

a first communication processing section configured to receive, according to a flight of a first mobile terminal performed based on a flight path to a first landing point, information on one or more second landing points associated with the flight path to the first landing point via a communication network; and

a control section configured to perform landing operation at a landing scheduled point different from the first landing point according to the information on the one or more second landing points.

### (Supplementary Note 14)

The first mobile terminal according to supplementary note 13, wherein the information on the one or more second landing points is information on a plurality of second landing points.

### (Supplementary Note 15)

The first mobile terminal according to supplementary note 14, wherein the control section is configured to determine the landing scheduled point out of the plurality of second landing points, based on a current position of the first mobile terminal.

### (Supplementary Note 16)

The first mobile terminal according to supplementary note 14, wherein

the control section is configured to configure priority for the first mobile terminal to preferentially land for each of the plurality of second landing points, based on a type of the first mobile terminal.

### (Supplementary Note 17)

The first mobile terminal according to any one of supplementary notes 13 to 16, wherein

the control section is configured to, when communication via the communication network by the first mobile terminal is disconnected, start landing operation at the landing scheduled point, based on the information on the one or more second landing points.

### (Supplementary Note 18)

The first mobile terminal according to any one of supplementary notes 13 to 17, further including:

a notification processing section configured to notify one or more second mobile terminals of information on the landing scheduled point when communication via the communication network by the first mobile terminal is disconnected.

(Supplementary Note 19)

The first mobile terminal according to any one of supplementary notes 13 to 18, further including:

a second communication processing section configured to receive, from one or more second mobile terminals, information on the landing scheduled point at which the one or more second mobile terminals perform landing, wherein

the control section is configured to change the landing scheduled point at which the one or more second mobile terminals perform landing, according to the information on the landing scheduled point at which the one or more second mobile terminals perform landing.

### (Supplementary Note 20)

A method including:

acquiring, according to a flight of a first mobile terminal performed based on a flight path to a first landing point, information on one or more second landing points associated with the flight path to the first landing point; and

transmitting the information on the one or more second landing points to the first mobile terminal via a communication network.

### (Supplementary Note 21)

A method including:

receiving, according to a flight of a first mobile terminal performed based on a flight path to a first landing point, information on one or more second landing points associated with the flight path to the first landing point via a communication network; and

performing landing operation at a landing scheduled point different from the first landing point according to the information on the one or more second landing points.

### (Supplementary Note 22)

A program that causes a processor to execute:

acquiring, according to a flight of a first mobile terminal performed based on a flight path to a first landing point, information on one or more second landing points associated with the flight path to the first landing point; and

transmitting the information on the one or more second landing points to the first mobile terminal via a communication network.

### (Supplementary Note 23)

A program that causes a processor to execute:

receiving, according to a flight of a first mobile terminal performed based on a flight path to a first landing point, information on one or more second landing points associated with the flight path to the first landing point via a communication network; and

performing landing operation at a landing scheduled point different from the first landing point according to the information on the one or more second landing points.

### (Supplementary Note 24)

A non-transitory computer readable recording medium storing a program that causes a processor to execute:

acquiring, according to a flight of a first mobile terminal performed based on a flight path to a first landing point, information on one or more second landing points associated with the flight path to the first landing point; and

transmitting the information on the one or more second landing points to the first mobile terminal via a communication network.

### (Supplementary Note 25)

A non-transitory computer readable recording medium storing a program that causes a processor to execute:

receiving, according to a flight of a first mobile terminal performed based on a flight path to a first landing point, information on one or more second landing points associated with the flight path to the first landing point via a communication network; and

performing landing operation at a landing scheduled point different from the first landing point according to the information on the one or more second landing points.

This application claims priority based on JP 2019-161401 filed on Sep. 4, 2019, the entire disclosure of which is incorporated herein.

### INDUSTRIAL APPLICABILITY

In a system in which a flight of a mobile terminal is performed, the mobile terminal can land at an appropriate landing point in reaction to a change of an incident that may occur while the mobile terminal along a flight path.

Reference Signs List

| | |
|---|---|
| 1, 2 | System |
| 100, 500 | Control Apparatus |
| 200, 200a, 200b, 200c | Mobile Terminal |
| 600 | First Mobile Terminal |
| 131, 511 | Information Acquisition Section |
| 133, 241, 611 | First Communication Processing Section |
| 135, 243 | Second Communication Processing Section |
| 245 | Notification Processing Section |
| 247, 613 | Control Section |
| 513 | Communication Processing Section |

What is claimed is:

1. A control apparatus comprising:
a memory storing instructions; and
one or more processors configured to execute the instructions to:
acquire, according to a flight of a first mobile terminal performed based on a flight path to a first landing point, information on one or more second landing points associated with the flight path to the first landing point; and
transmit the information on the one or more second landing points to the first mobile terminal via a communication network.

2. The control apparatus according to claim 1, wherein
the one or more second landing points are present at or within a predetermined distance from the flight path to the first landing point.

3. The control apparatus according to claim 1, wherein
the flight path to the first landing point is configured based on a plurality of zones capable of identifying a three-dimensional space in common among a plurality of mobile communication networks managed by a plurality of mobile communication carriers performing radio communication with a mobile terminal, and
the one or more second landing points are point(s) identified based on one or more zones to which the flight path to the first landing point belongs.

4. The control apparatus according to claim 3, wherein
the one or more processors are configured to transmit the information on the one or more second landing points to the first mobile terminal via a mobile communication network performing radio communication with the first mobile terminal.

5. The control apparatus according to claim 1, wherein
the one or more second landing points are information acquired according to information on an operation state of the first mobile terminal.

6. The control apparatus according to claim 1, wherein
the one or more second landing points are information acquired according to information on a condition of the flight path to the first landing point.

7. The control apparatus according to claim 1, wherein
the one or more second landing points are information acquired according to information on a type of the first mobile terminal.

8. The control apparatus according to claim 1, wherein
the information on the one or more second landing points is information on a plurality of second landing points, and
the information on the plurality of second landing points includes information indicating priority for the first mobile terminal to preferentially land for each of the plurality of second landing points.

9. The control apparatus according to claim 8, wherein
the information indicating the priority is information acquired according to the information on a type of the first mobile terminal.

10. The control apparatus according to claim 1, wherein
the one or more processors are configured to transmit information instructing cancellation of the flight of the first mobile terminal performed based on the flight path to the first landing point, to the first mobile terminal via the communication network.

11. The control apparatus according to claim 10, wherein
the one or more processors are configured to transmit the information instructing cancellation of the flight of the first mobile terminal to the first mobile terminal via the communication network, based on information on a condition of the flight path to the first landing point.

12. The control apparatus according to claim 10, wherein
the information on the one or more second landing points is included in the information instructing cancellation of the flight of the first mobile terminal.

13. A first mobile terminal comprising:
a memory storing instructions; and
one or more processors configured to execute the instructions to:
receive, according to a flight of a first mobile terminal performed based on a flight path to a first landing point, information on one or more second landing points associated with the flight path to the first landing point via a communication network; and
perform landing operation at a landing scheduled point different from the first landing point according to the information on the one or more second landing points.

14. The first mobile terminal according to claim 13, wherein
the information on the one or more second landing points is information on a plurality of second landing points.

15. The first mobile terminal according to claim 14, wherein
the one or more processors are configured to determine the landing scheduled point out of the plurality of second landing points, based on a current position of the first mobile terminal.

16. The first mobile terminal according to claim 14, wherein
the one or more processors are configured to configure priority for the first mobile terminal to preferentially land for each of the plurality of second landing points, based on a type of the first mobile terminal.

17. The first mobile terminal according to claim 13, wherein
the one or more processors are configured to, when communication via the communication network by the first mobile terminal is disconnected, start landing operation at the landing scheduled point, based on the information on the one or more second landing points.

18. The first mobile terminal according to claim 13, wherein
the one or more processors are configured to notify one or more second mobile terminals of information on the landing scheduled point when communication via the communication network by the first mobile terminal is disconnected.

19. The first mobile terminal according to claim 13, wherein
the one or more processors are configured to
receive, from one or more second mobile terminals, information on the landing scheduled point at which the one or more second mobile terminals perform landing, and
change the landing scheduled point at which the one or more second mobile terminals perform landing, according to the information on the landing scheduled point at which the one or more second mobile terminals perform landing.

20. A method comprising:
acquiring, according to a flight of a first mobile terminal performed based on a flight path to a first landing point, information on one or more second landing points associated with the flight path to the first landing point; and
transmitting the information on the one or more second landing points to the first mobile terminal via a communication network.

21-25. (canceled)
